(19) United States
(12) Patent Application Publication
(10) Pub. No.: US 2026/0065519 A1
(43) Pub. Date: Mar. 5, 2026

(54) ADJUSTABLE VISUAL INTENSITY FOR IMAGE GENERATION

(71) Applicant: ADOBE INC., SAN JOSE, CA (US)

(72) Inventors: Hareesh Ravi, San Jose, CA (US); Ajinkya Gorakhnath Kale, San Jose, CA (US)

(21) Appl. No.: 18/823,857

(22) Filed: Sep. 4, 2024

(51) Int. Cl. G06T 11/00; G06F 3/048

(52) U.S. Cl. CPC G06T 11/00; G06F 3/048; G06T 2211/441

(57) ABSTRACT

An image generation method comprises obtaining a content prompt, a style prompt, and a visual intensity parameter, where the content prompt indicates an object, the style prompt indicates a style, and the visual intensity parameter indicates a level of the style. A content latent code and a style latent code are generated based on the content prompt and the style prompt, respectively, and the content latent code and the style latent code are combined based on the visual intensity parameter to obtain a combined latent code. An image generation model generates a synthetic image based on the combined latent code, where the synthetic image includes the object from the content prompt and the style from the style prompt at the level indicated by the visual intensity parameter.

### BACKGROUND

The following relates generally to image processing, and more specifically to generating synthetic images with controllable aesthetics and realism using machine learning. Image generation involves creating new images based on inputs such as user-provided prompts and style preferences. There are various approaches to generating images with different levels of realism and artistic style. However, balancing the trade-off between realism and aesthetics while providing user control remains a challenge.

Image generation can be performed using machine learning models, such as diffusion models. These models learn to generate high-quality images by training on large datasets of real-world images. Diffusion models, in particular, have shown promising results in generating high-quality images.

### SUMMARY

A method, apparatus, and non-transitory computer readable medium for image processing are described. One or more aspects of the method, apparatus, and non-transitory computer readable medium include obtaining a content prompt, a style prompt, and a visual intensity parameter, wherein the content prompt indicates an object, the style prompt indicates a style, and the visual intensity parameter indicates a level of the style; generating a content latent code and a style latent code based on the content prompt and the style prompt, respectively; combining the content latent code and the style latent code based on the visual intensity parameter to obtain a combined latent code; and generating, using an image generation model, a synthetic image based on the combined latent code, wherein the synthetic image includes the object from the content prompt and the style from the style prompt at the level indicated by the visual intensity parameter.

A method, apparatus, and non-transitory computer readable medium for image processing are described. One or more aspects of the method, apparatus, and non-transitory computer readable medium include obtaining an aesthetic score, a content prompt, and a style prompt; generating a content latent code based on the content prompt and the aesthetic score; generating a style latent code based on the style prompt; combining the content latent code and the style latent code to obtain a combined latent code; and generating, using an image generation model, a synthetic image based on the combined latent code.

An apparatus and method for image processing are described. One or more aspects of the apparatus and method include at least one processor; at least one memory storing instruction executable by the at least one processor; and an image generation model comprising parameters stored in the at least one memory and trained to generate a content latent code and a style latent code based on a content prompt and a style prompt, respectively, combine the content latent code and the style latent code based on a visual intensity parameter to obtain a combined latent code, and generate a synthetic image based on the combined latent code.

### BRIEF DESCRIPTION OF THE DRAWINGS

FIG. 1 shows an example of an image processing system according to aspects of the present disclosure.

FIG. 2 shows an example of an image processing application according to aspects of the present disclosure.

FIG. 3 shows an example of an image processing method according to aspects of the present disclosure.

FIG. 4 shows examples of synthetic images according to aspects of the present disclosure.

FIG. 5 shows an example of an image processing apparatus according to aspects of the present disclosure.

FIG. 6 shows an example of an image generation model according to aspects of the present disclosure.

FIGS. 7 through 8 show examples of methods for image processing according to aspects of the present disclosure.

FIG. 9 shows an example of a computing device according to aspects of the present disclosure.

### DETAILED DESCRIPTION

The following relates generally to image processing, and more specifically to generating synthetic images with controllable aesthetics and realism using machine learning. Image generation involves creating new images based on user-provided text prompts and style preferences. There are various approaches to generating images with different levels of realism and artistic style. However, balancing the trade-off between realism and aesthetics while providing user control remains a challenge. Some image generation methods do not provide explicit control over the balance between realism and artistic style. Some image generation models are trained to generate images that prioritize either realism or aesthetics, but not both. This may result in generated images that are either overly literal representations of the input text prompt or highly stylized images that lack coherence and consistency with the desired content. Users often have limited ability to adjust the level of stylization or realism in the generated images to suit their preferences.

Image generation can be performed using machine learning models, such as diffusion models. These models learn to generate high-quality images by training on large datasets of real-world images. Diffusion models, in particular, have shown promising results in generating diverse and realistic images. However, some image generation methods often struggle to provide users with fine-grained control over the visual style and aesthetic qualities of the generated images. Some image generation models lack the ability to effectively combine semantic content from text prompts with specific artistic styles.

Embodiments of the present disclosure improve on conventional image generation models by increasing the accuracy of generated outputs. For example, embodiments enable the controllability and flexibility of image generation, allowing users to explicitly adjust the balance between realism and aesthetics in the generated images at varying levels of intensity. In some embodiments, a visual intensity parameter enables users to control the extent to which the stylistic elements are incorporated into the output images. An image generation takes the visual intensity parameter as input and uses it to create a features that combine a target content with a target style.

By providing a user-adjustable parameter that ranges from low to high intensity, the present invention allows users to generate images that span from highly realistic representations to heavily stylized artistic renditions, with fine-grained control over the level of stylization. Embodiments of the present disclosure achieves these improvements by generating a content latent code based on a content prompt and a style latent code based on a style prompt, combining the content latent code and the style latent code based on the visual intensity parameter to obtain a combined latent code, and generates a synthetic image using an image generation model.

### Image Processing System

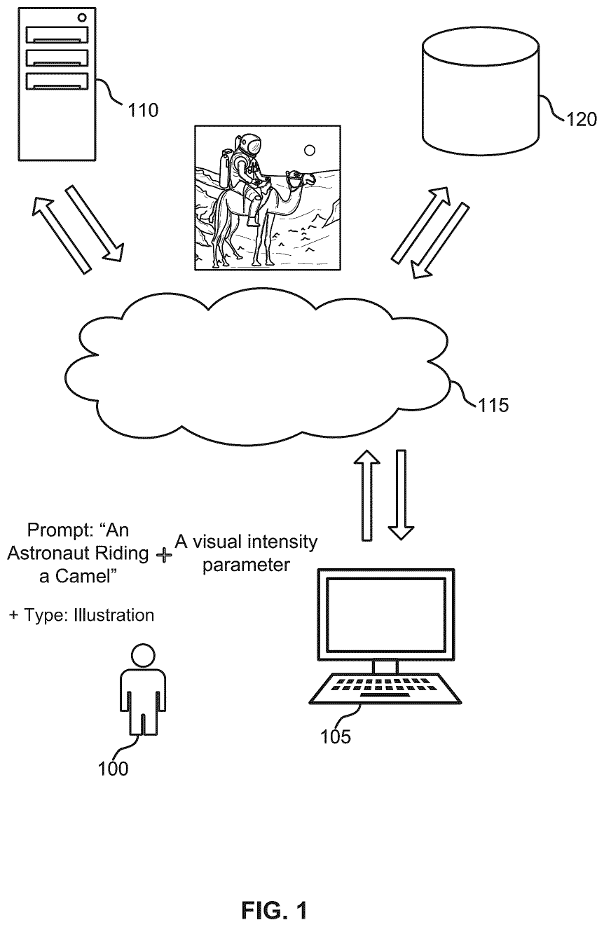

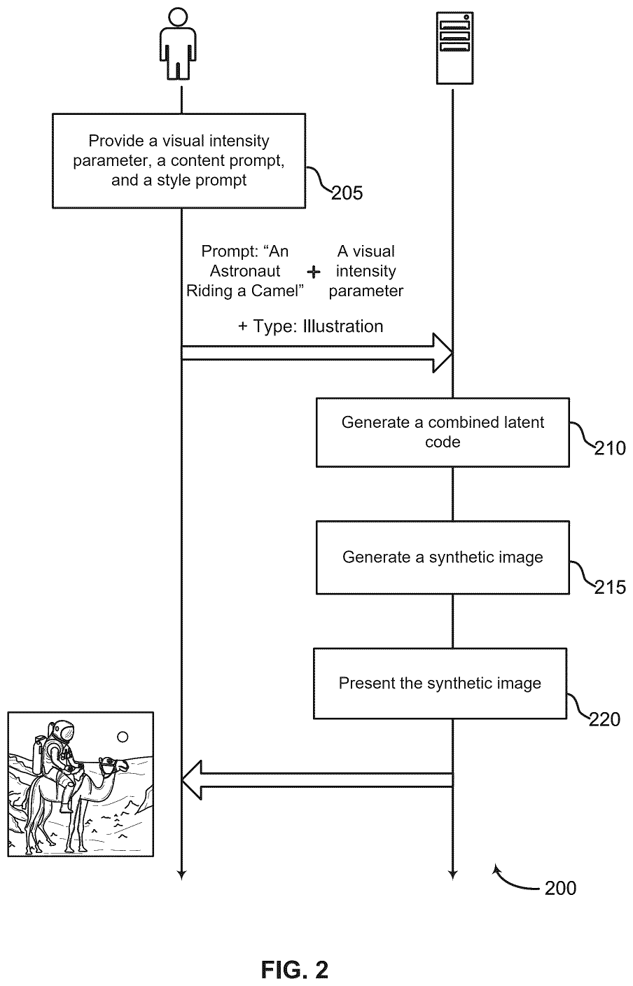

FIG. 1 shows an example of an image processing system according to aspects of the present disclosure. The example shown includes user 100, user device 105, image processing apparatus 110, cloud 115, and database 120. Image processing apparatus 110 is an example of, or includes aspects of, the corresponding element described with reference to FIGS. 2-6, and 9.

In the example shown in FIG. 1, user 100 provides a text prompt, such as “An astronaut riding a camel”, and a visual intensity parameter to the image processing apparatus 110 via user device 105 and cloud 115. The image processing apparatus 110 processes this input to generate a synthetic image that represents the content of the text prompt with a style and aesthetic quality controlled by the visual intensity parameter. The image processing apparatus 110 employs a text encoder to analyze the text prompt and extract relevant semantic information, generating a text embedding. Simultaneously, an image encoder processes a style prompt associated with the text prompt, mapping the style prompt to a style latent space and generating a style latent code that encodes the desired stylistic attributes.

The text embedding and the style latent code are then combined based on the visual intensity parameter using an image projector. The resulting combined latent code represents the fusion of the content and style information, weighted according to the visual intensity parameter. In some examples, the combined latent code is then fed into a latent diffusion model, which generates the final synthetic image. In this example, the output image generated by the image processing apparatus 110 depicts an astronaut riding a camel, as specified by the text prompt, with the visual style and aesthetic quality influenced by the visual intensity parameter.

In this example, the resultant output image is then returned to the user 100 via cloud 115 and user device 105, allowing the user to view the creative interpretation of their text prompt with the desired level of stylization and aesthetic quality. User device 105 may be a personal computer, laptop computer, mainframe computer, palmtop computer, personal assistant, mobile device, or any other suitable processing apparatus. In some examples, user device 105 includes software that incorporates an image processing application (e.g., query answering, image editing, relationship detection). In some examples, the image editing application on user device 105 may include functions of image processing apparatus 110.

A user interface may enable user 100 to interact with user device 105. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a user interface may be represented in code that is sent to the user device 105 and rendered locally by a browser. The process of using the image processing apparatus 110 is further described with reference to FIG. 2.

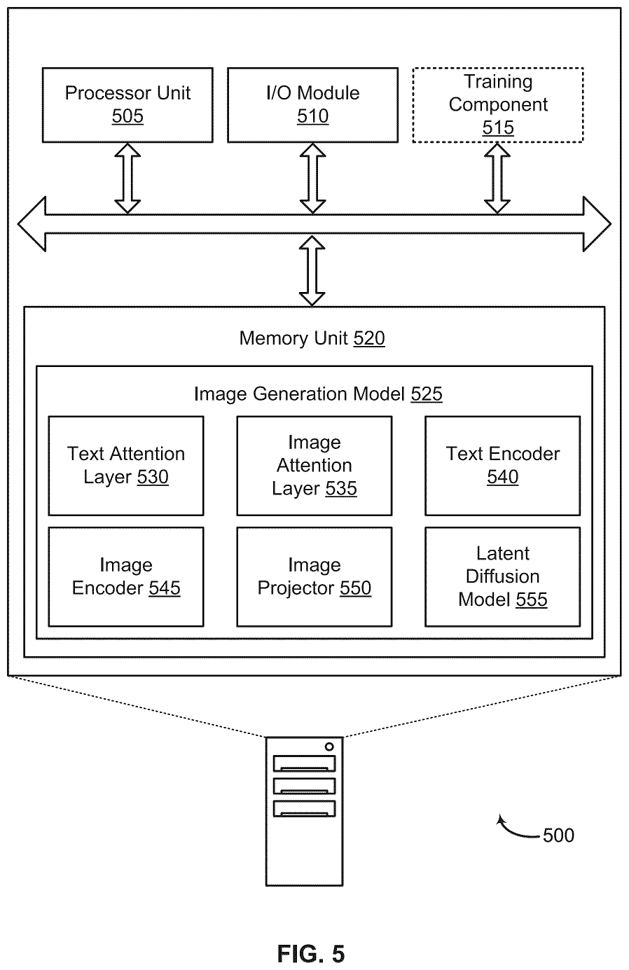

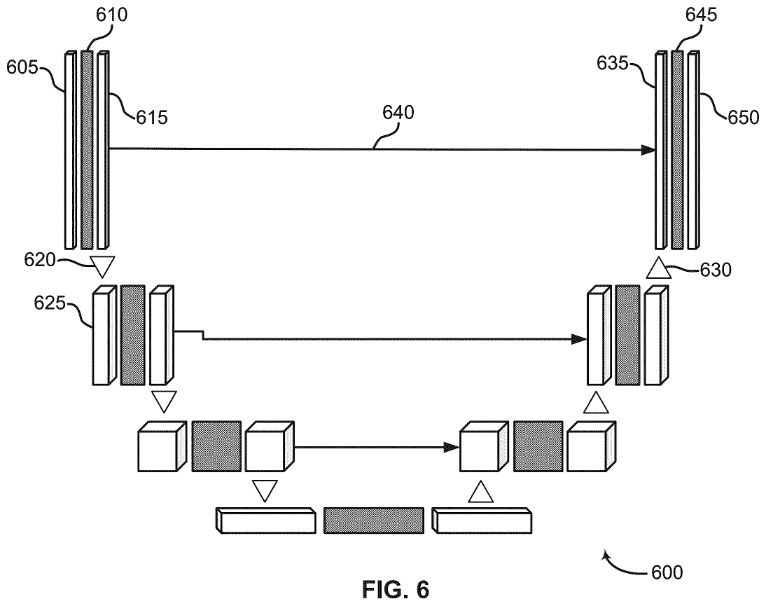

Image processing apparatus 110 includes a computer implemented network comprising an image encoder, a text encoder, a multi-modal encoder, and a decoder. Image processing apparatus 110 may also include a processor unit, a memory unit, an I/O module, and a training component. The training component is used to train a machine learning model (or an image processing network). Additionally, image processing apparatus 110 can communicate with database 120 via cloud 115. In some cases, the architecture of the image processing network is also referred to as a network, a machine learning model, or a network model. Further detail regarding the architecture of image processing apparatus 110 is provided with reference to FIGS. 5-6. Further detail regarding the operation of image processing apparatus 110 is provided with reference to FIGS. 5-6.

In some cases, image processing apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user interacts with the database controller. In other cases, database controllers may operate automatically without user interaction.

FIG. 2 shows an example of an image processing application 200 according to aspects of the present disclosure. The image processing application 200 is an example of, or includes aspects of, the corresponding element described with reference to FIGS. 1, 3-6, and 9.

At operation 205, the user provides a visual intensity parameter, a content prompt, and a style prompt. In this example, the content prompt is “An astronaut riding a camel”, which specifies the main subject and action to be depicted in the generated image. A style prompt (i.e., “illustration”) can be included in the text prompt or specified separately such as through a selection of one from a set of preset style selections. The style prompt can also include styles such as “oil painting” or “watercolor”, and indicates the desired artistic style or visual elements to be incorporated into the image. In some examples, the visual intensity parameter is a user-specified value that controls the balance between realism and stylization in the output image.

The visual intensity parameter can be set manually by the user (e.g., by setting the position of a visual intensity UI element). Additionally or alternatively, it can be set at a default level for the image generation system. In some cases the visual intensity parameter can be obtained or inferred from the text prompt. For example, the text prompt might include language such as “highly photorealistic” or “slightly cartoonish” that indicates both a style a level of intensity for the style.

At operation 210, the system generates a combined latent code. The content prompt is processed by a text encoder, which converts the textual description into a dense vector representation called the text embedding. In some examples, the text embedding captures the semantic meaning and key elements of the content prompt. Simultaneously, the style prompt is processed by an image encoder, which maps the style prompt to a style latent space and generates a style latent code that encodes the desired stylistic attributes.

In this example, the text embedding and the style latent code are then combined using an image projector. The image projector applies learned projection techniques to blend the content and style information based on the visual intensity parameter. Operation 210 generates a combined latent code that represents the combination of the content and style that are weighted according to the user's preference for realism versus aesthetics.

At operation 215, the system generates a synthetic image. In this example, the combined latent code is fed into a latent diffusion model. The latent diffusion model may be a deep generative model trained to map latent codes to high-quality images.

In some examples, the latent diffusion model applies a series of denoising and upsampling operations to the combined latent code, progressively refining and generating the final synthetic image. The generated image depicts an astronaut riding a camel, as specified by the content prompt, with the visual style and aesthetic quality influenced by the style prompt and the visual intensity parameter.

At operation 220, the system presents the synthetic image to the user. For example, at operation 220, the generated image is returned to the user via the same interface or platform where the user provided the initial inputs.

In some examples, the user can view the creative interpretation of their content prompt, featuring an astronaut riding a camel, with the desired level of stylization and aesthetic quality as controlled by the visual intensity parameter and the style prompt. This process may facilitate transforming the users' textual descriptions and preferences into visually compelling images that integrate the specified content and styles.

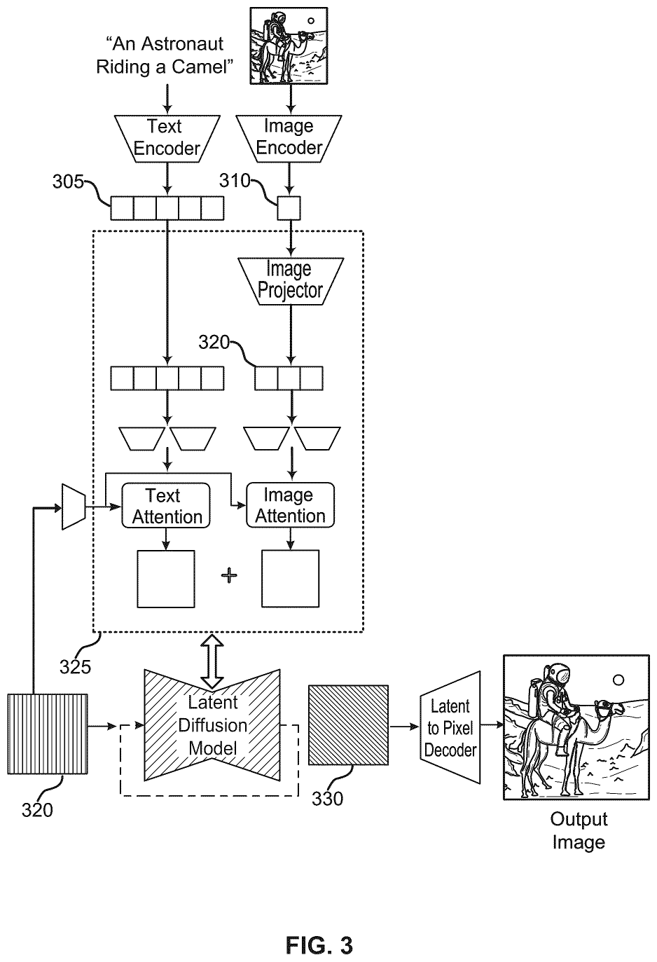

FIG. 3 shows an example of image processing process 300 according to aspects of the present disclosure. The image processing process 300 is an example of, or includes aspects of, the corresponding element described with reference to FIGS. 1, 2, 4-6, and 9.

The image processing process 300 begins with a text prompt “An Astronaut Riding a Camel” being input into a text encoder. Simultaneously, an image depicting an astronaut riding a camel is input into an image encoder. The text encoder generates a text embedding 305 based on the text prompt, while the image encoder generates an image embedding 310 based on the input image. The image embedding 310 is then processed by an image projector, generating a projected image embedding 315.

The text embedding 305 is passed through a series of text attention layers, which extract relevant features and contextual information from the text representation. Similarly, the projected image embedding 315 is processed by a sequence of image attention layers, capturing the essential visual characteristics and spatial relationships within the image.

Next, the processed text embedding and the processed projected image embedding are input into an image attention layer, generating an image-attended representation. This image-attended representation combines the salient features from both the text and image modalities, allowing the model to understand the semantic connections between the textual description and the visual content. Concurrently, an input noise latent code 320 is processed by a text attention layer, generating a text-attended representation. The input noise latent code 320 introduces stochasticity into the generation process, enabling the model to produce diverse and creative outputs.

The image-attended representation and the text-attended representation are then combined, generating an output latent code 330. This output latent code 330 encapsulates the fused information from both the text and image modalities, along with the stochastic elements introduced by the input noise latent code 325.

Finally, the output latent code 330 is processed by a latent-to-pixel decoder, which maps the abstract representation to a high-resolution output image. The latent-to-pixel decoder utilizes the learned features and relationships captured in the output latent code 330 to generate a visually coherent and semantically meaningful image that aligns with the input text prompt and the provided image.

According to embodiments of the present disclosure, in an alternative embodiment, the image embeddings and the text embeddings are processed separately. By employing learnable projection layers for the image embeddings, the model can attend to both text and image independently. In some examples, this embodiment enables the system to assign higher weights to image conditioning during training, such as 30%, without the image dominating the learning process.

In some examples, the system addresses the limitation of using a single flattened image embedding by projecting the input image embedding 310 into multiple projected image embeddings 315 using a learnable image projector. This process may be used to enable the cross-attention mechanism to capture meaningful information from the image and improves the capacity for image-based learning. The separate learnable cross-attention layers for text and image may act on the text embedding 305 and the projected image embeddings 315 in parallel, generating cross-attention outputs for both modalities. These outputs are then combined through addition, enabling the model to learn from both text and image representations.

According to some embodiments, based on the value of the visual intensity parameter, the image generation model 525 sets some values including the aesthetic score, the weight for content or text, and the weight for the style or image. The aesthetic score determines the overall level of stylization applied to the generated image. The weights for content and style control the relative influence of the text-attended representation and the image-attended representation in the combined latent code.

In some examples, the weights for content and style are pre-determined based on the desired effect at each value of the visual intensity slider, allowing for a smooth transition from realism to aesthetics. In these examples, the differences in the latent codes are not solely determined by the weights, as the weights remain consistent across all layers of the image generation model 525. In these examples, the layer-specific projection layers for text and image, implemented in the text attention layer 530 and the image attention layer 535, respectively, may contribute to the variations in the latent codes. In some examples, these projection layers enable the model to learn and generate distinct representations for different levels of the visual intensity parameter.

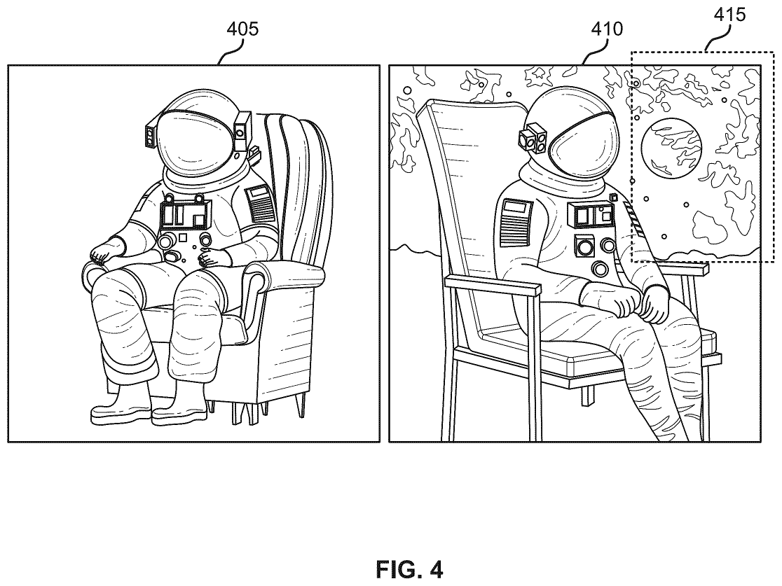

FIG. 4 shows an example of synthetic images 400 according to aspects of the present disclosure. The synthetic images 400 are examples of, or include aspects of, the corresponding element described with reference to FIGS. 1-3, 5, 6, and 9.

FIG. 4 illustrates the effect of the visual intensity parameter on the generated output image. The figure presents two images including image 405 with a low aesthetic score and image 410 with a high aesthetic score. Both images depict an astronaut sitting on a chair, but the visual elements and overall style vary based on the aesthetic score.

In image 405, which has a low aesthetic score, the generated output focuses on representing the astronaut and the chair in a realistic manner. The image aims to capture the scene as it would appear in a real-life setting, without adding extra artistic or stylistic elements. The astronaut's suit, the chair, and the surrounding environment are rendered in a way that closely resembles a photograph taken in a studio or a similar setting.

Image 410 is generated based on a high aesthetic score. Image 410 incorporates additional visual elements and themes that enhance the aesthetic expression of the scene. The most notable difference is the presence of part 415, which depicts stars, space, and other cosmic elements. These elements are not typically present when taking a picture of an astronaut sitting on a chair in a realistic setting. Instead, they serve as an artistic representation of the themes and concepts associated with astronauts and space exploration.

The inclusion of part 415 in image 410 demonstrates the increased aesthetic expression resulting from a higher aesthetic score. The model interprets the text prompt and the image embedding, and based on the high aesthetic score, it generates visually appealing and thematically relevant elements that go beyond a literal representation of the scene. The stars, space, and other cosmic elements in part 415 add a sense of wonder, adventure, and creativity to the image, making it more visually striking and imaginative compared to the realistic portrayal in image 405.

FIG. 4 demonstrates the impact of the visual intensity parameter on the generated output. A low aesthetic score prioritizes realism and faithfulness to the input image and text prompt, while a high aesthetic score allows for more artistic freedom, stylization, and the incorporation of thematic elements that enhance the overall aesthetic appeal of the generated image. The presence of part 415 in image 410 exemplifies the increased aesthetic expression achieved through the use of a high aesthetic score in the image generation process.

Accordingly, a method for image processing includes obtaining a visual intensity parameter, a content prompt, and a style prompt, wherein the content prompt indicates an object and the style prompt indicates a style; generating a content latent code and a style latent code based on the content prompt and the style prompt, respectively; combining the content latent code and the style latent code based on the visual intensity parameter to obtain a combined latent code; and generating, using an image generation model, a synthetic image based on the combined latent code, wherein the synthetic image includes the object from the content prompt, and wherein the synthetic image includes the style from the style prompt at a level based on the visual intensity parameter.

Some examples of the method, apparatus, and non-transitory computer readable medium further include obtaining the visual intensity parameter comprises: receiving a user input via a visual intensity user interface element. Some examples of the method, apparatus, and non-transitory computer readable medium further include obtaining the content prompt and the style prompt comprises: obtaining a text prompt, wherein the content prompt and the style prompt are based on the text prompt.

Some examples of the method, apparatus, and non-transitory computer readable medium further include generating the style latent code comprises: encoding the style prompt to obtain a text embedding; and projecting the text embedding to obtain an image embedding, wherein the style latent code is based on the image embedding. Some examples of the method, apparatus, and non-transitory computer readable medium further include determining an aesthetic score based on the visual intensity parameter, wherein the content latent code is based on the aesthetic score.

Some examples of the method, apparatus, and non-transitory computer readable medium further include generating the content latent code and the style latent code comprises: encoding the content prompt to obtain a text embedding; encoding the style prompt to obtain an image embedding; applying a text attention layer to the text embedding to obtain the content latent code; and applying an image attention layer to the image embedding to obtain the style latent code. Some examples of the method, apparatus, and non-transitory computer readable medium further include generating the content latent code and the style latent code comprises: obtaining a noisy latent code, wherein the content latent code and the style latent code are generated based on the noisy latent code.

Some examples of the method, apparatus, and non-transitory computer readable medium further include generating the synthetic image comprises: denoising the noisy latent code based on the combined latent code. Some examples of the method, apparatus, and non-transitory computer readable medium further include generating the synthetic image comprises: providing the combined latent code to each of a plurality of layers of the image generation model.

One or more aspects of the method include obtaining a visual intensity parameter, an aesthetic score, a content prompt, and a style prompt; generating a content latent code based on the content prompt and the aesthetic score; generating a style latent code based on the style prompt; combining the content latent code and the style latent code based on the visual intensity parameter to obtain a combined latent code; and generating, using an image generation model, a synthetic image based on the combined latent code. In some aspects, the aesthetic score is based on the visual intensity parameter.

Some examples of the method, apparatus, and non-transitory computer readable medium further include generating the content latent code and the style latent code comprises: encoding the content prompt to obtain a text embedding; encoding the style prompt to obtain an image embedding; applying a text attention layer to the text embedding to obtain the content latent code; and applying an image attention layer to the image embedding to obtain the style latent code.

### Image Processing Apparatus

FIG. 5 shows an example of an image processing apparatus 500 according to aspects of the present disclosure. The image processing apparatus 500 is an example of, or includes aspects of, the corresponding element described with reference to FIGS. 1-4, 6, and 9.

Processor unit 505 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

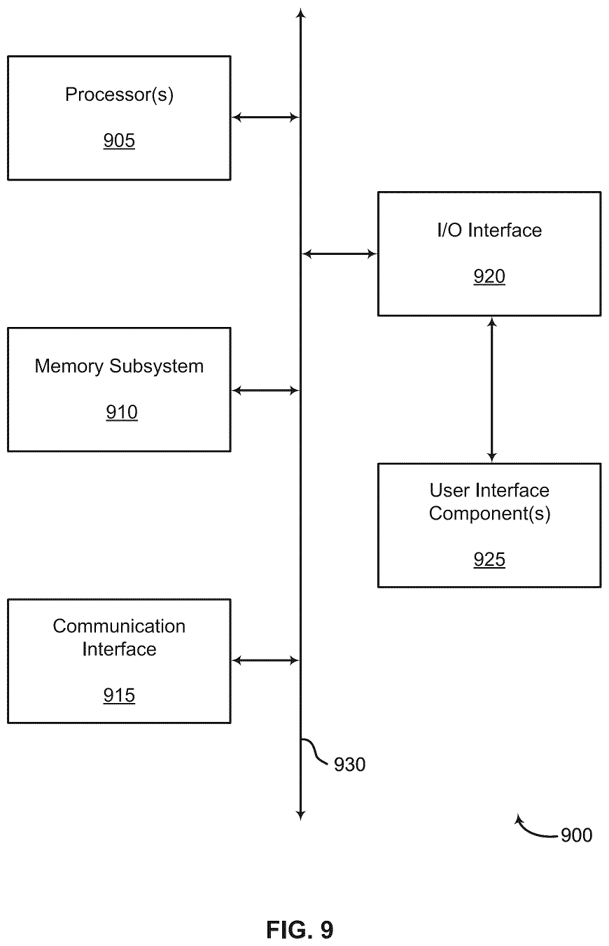

In some cases, processor unit 505 is configured to operate a memory array using a memory controller. In other cases, a memory controller is integrated into processor unit 505. In some cases, processor unit 505 is configured to execute computer-readable instructions stored in memory unit 520 to perform various functions. In some aspects, processor unit 505 includes special purpose components for modem processing, baseband processing, digital signal processing, or transmission processing. According to aspects, processor unit 505 comprises one or more processors described with reference to FIG. 9.

Memory unit 520 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 505 to perform various functions described herein.

In some cases, memory unit 520 includes a basic input/output system (BIOS) that controls basic hardware or software operations, such as an interaction with peripheral components or devices. In some cases, memory unit 520 includes a memory controller that operates memory cells of memory unit 520. For example, the memory controller may include a row decoder, column decoder, or both. In some cases, memory cells within memory unit 520 store information in the form of a logical state. According to aspects, memory unit 520 comprises the memory subsystem described with reference to FIG. 9.

According to aspects, image generation apparatus 500 uses one or more processors of processor unit 505 to execute instructions stored in memory unit 520 to perform functions described herein. For example, in some cases, the image generation apparatus 500 obtains a prompt describing an image element. For example, the image element may be corresponding to a plurality of concepts.

Machine learning parameters, also known as model parameters or weights, are variables that provide a behavior and characteristics of a machine learning model. Machine learning parameters can be learned or estimated from training data and are used to make predictions or perform tasks based on learned patterns and relationships in the data.

Machine learning parameters are typically adjusted during a training process to minimize a loss function or maximize a performance metric. The goal of the training process is to find optimal values for the parameters that allow the machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

Artificial neural networks (ANNs) have numerous parameters, including weights and biases associated with each neuron in the network, which control a degree of connections between neurons and influence the neural network's ability to capture complex patterns in data.

An ANN is a hardware component or a software component that includes a number of connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

In some cases, the signals between nodes comprise real numbers, and the output of each node is computed by a function of the sum of its inputs. In some examples, nodes may determine their output using other mathematical algorithms, such as selecting the max from the inputs as the output, or any other suitable algorithm for activating the node. Each node and edge are associated with one or more node weights that determine how the signal is processed and transmitted.

In ANNs, a hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

During a training process of an ANN, the node weights are adjusted to improve the accuracy of the result (i.e., by minimizing a loss which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

According to aspects, the image generation model 525 includes text attention layer 530, image attention layer 535, text encoder 540, image encoder 545, image projector 550, and latent diffusion model 555. The image generation model 525 is a machine learning model.

Text attention layer 530 processes the text embedding generated by the text encoder 540. Text attention layer 530 applies attention mechanisms to the text embedding. The attention mechanisms help to focus on the most relevant information in the text embedding. Text attention layer 530 generates a text-attended representation that captures the important semantic details from the input text prompt.

Image attention layer 535 processes the projected image embedding generated by the image projector 550. Image attention layer 535 applies attention mechanisms to the projected image embedding. The attention mechanisms help to focus on the most relevant visual features in the projected image embedding. Image attention layer 535 generates an image-attended representation that captures the important stylistic details from the input style prompt.

Text encoder 540 takes the content prompt as input. Text encoder 540 processes the content prompt using natural language processing techniques. Text encoder 540 converts the content prompt into a dense vector representation called the text embedding. The text embedding captures the semantic meaning and key elements of the content prompt. Text encoder 540 passes the text embedding to the text attention layer 530 for further processing.

Image encoder 545 takes the style prompt as input. Image encoder 545 processes the style prompt using pre-trained style encoding models. Image encoder 545 maps the style prompt to a style latent space. In some examples, each point in the style latent space represents a specific artistic style or aesthetic. Image encoder 545 generates a style latent code that encodes the desired stylistic attributes specified by the style prompt.

Image projector 550 takes the style latent code generated by the image encoder 545 as input. Image projector 550 applies learned projection techniques to the style latent code. Image projector 550 transforms the style latent code into a projected image embedding. In some examples, the projected image embedding has a format that is compatible with the latent diffusion model 555. Image projector 550 passes the projected image embedding to the image attention layer 535 for further processing.

Latent diffusion model 555 takes the combined latent code as input. The combined latent code is obtained by combining the text-attended representation from the text attention layer 530 and the image-attended representation from the image attention layer 535 based on the visual intensity parameter. In some examples, latent diffusion model 555 is a deep generative model trained to map latent codes to high-quality images. In some examples, latent diffusion model 555 applies a series of denoising and upsampling operations to the combined latent code. Through these operations, latent diffusion model 555 progressively refines and generates the final synthetic image that incorporates the content and style specified by the input prompts.

FIG. 6 shows an example of an image generation model 600 according to aspects of the present disclosure. The image generation model 600 is an example of, or includes aspects of, the corresponding element described with reference to FIGS. 1-4, 6, and 9.

FIG. 6 shows an example of an image processing model 600 according to aspects of the present disclosure. The image processing model 600 is an example of, or includes aspects of, the corresponding element described with reference to FIGS. 1-4, 6, and 9. According to some aspects, image generation model 600 comprises a diffusion model including an ANN architecture such as a U-Net.

According to some aspects, image generation model 600 receives input features 605, where input features 605 include an initial resolution and an initial number of channels, and processes input features 605 using an initial neural network layer 610 (e.g., a convolutional neural network layer) to produce intermediate features 615. In some cases, intermediate features 615 are then down-sampled using a down-sampling layer 620 such that down-sampled features 625 have a resolution less than the initial resolution and a number of channels greater than the initial number of channels.

In some cases, this process is repeated multiple times, and then the process is reversed. For example, down-sampled features 625 are up-sampled using up-sampling process 630 to obtain up-sampled features 635. In some cases, up-sampled features 635 are combined with intermediate features 615 having the same resolution and number of channels via skip connection 640. In some cases, the combination of intermediate features 615 and up-sampled features 635 are processed using final neural network layer 645 to produce output features 650. In some cases, output features 650 have the same resolution as the initial resolution and the same number of channels as the initial number of channels.

According to some aspects, image generation model 600 receives additional input features to produce a conditionally generated output. In some cases, the additional input features include a vector representation of an input prompt. In some cases, the additional input features are combined with intermediate features 615 within Image generation model 600 at one or more layers. For example, in some cases, a cross-attention module is used to combine the additional input features and intermediate features 615.

According to embodiments of the present disclosure, a method, apparatus, and non-transitory computer readable medium for training a machine learning model are described. One or more aspects of the method include obtaining a training set including a ground-truth image depicting an entity, pose information indicating a target pose of the entity, and a part image depicting a target part of the entity and training, using the training set, an image generation model to generate an output image that depicts the entity with the target pose and the target part.

Some examples of the method, apparatus, and non-transitory computer readable medium for training a machine learning model comprise computing a multi-task loss function including an entity-part loss term and a pose-warp loss term; and updating parameters of the image generation model based on the multi-task loss function. In some aspects, the entity-part loss term is based on a segmentation map for the target part of the entity. In some aspects, the pose-warp loss term is based on a visibility map corresponding to the target pose of the entity. In some aspects, the multi-task loss function includes a diffusion loss term. Some examples of the method for training a machine learning model comprises obtaining the training set comprises applying a pose detection model to the ground-truth image to the pose information. Some examples of the method, apparatus, and non-transitory computer readable medium for training a machine learning model further include obtaining the training set comprises applying a segmentation model to the ground-truth image to obtain the part image. In some cases, obtaining a training set can include creating training samples for training the machine learning model.

Accordingly, an apparatus for image processing includes at least one processor; at least one memory storing instruction executable by the at least one processor; and an image generation model comprising parameters stored in the at least one memory and trained to generate a content latent code and a style latent code based on a content prompt and a style prompt, respectively, combine the content latent code and the style latent code based on a visual intensity parameter to obtain a combined latent code, and generate a synthetic image based on the combined latent code.

In some aspects, the image generation model comprises a text attention layer configured to generate the content latent code and an image attention layer configured to generate the style latent code. In some aspects, the image generation model comprises a text encoder configured to generate a text embedding based on the content prompt. In some aspects, the image generation model comprises an image encoder configured to generate an image embedding based on the style prompt.

In some aspects, the image generation model comprises an image projector configured to convert a text embedding into an image embedding. In some aspects, the image generation model comprises a latent diffusion model. Some examples of the apparatus and method further include a user interface configured to obtain the visual intensity parameter, the content prompt, and the style prompt. Some examples of the apparatus and method further include a visual intensity user interface element configured to obtain the visual intensity parameter.

### Image Processing Methods

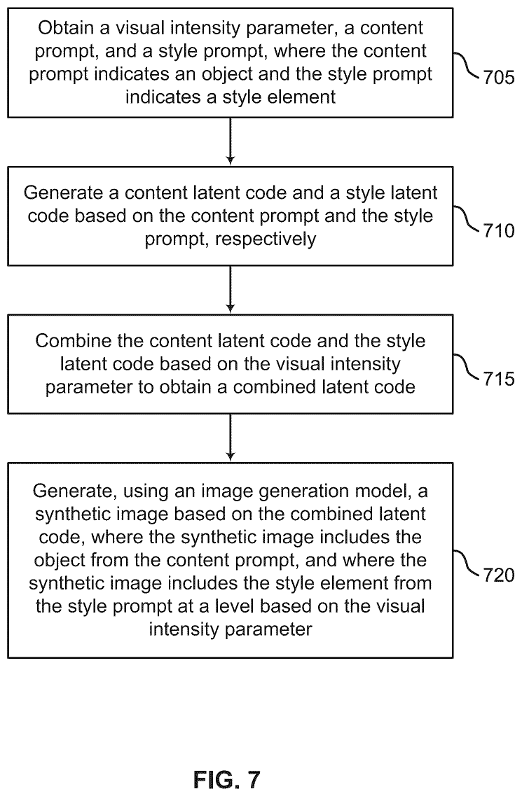

FIG. 7 shows an example of a method 700 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 705, the system obtains a visual intensity parameter, a content prompt, and a style prompt, where the content prompt indicates an object and the style prompt indicates a style. In some cases, the operations of this step refer to, or may be performed by, a machine learning model as described with reference to FIG. 5.

In some examples, the visual intensity parameter is a user-specified value that determines the level of aesthetic expression in the generated image. The visual intensity parameter may control the balance between realism and stylization, allowing the user to adjust the visual appearance of the output image according to their preferences. In some examples, the content prompt is a textual description of the main subject or object to be depicted in the image. The content prompt may provide the system with information about the target content. The style prompt specifies the artistic style or aesthetic elements to be incorporated into the image.

At operation 710, the system generates a content latent code and a style latent code based on the content prompt and the style prompt, respectively. In some cases, the operations of this step refer to, or may be performed by, an image generation model as described with reference to FIG. 5.

In some examples, the content latent code is a compressed representation of the semantic information contained in the content prompt. The content latent code captures the essential features and characteristics of the main subject or object described in the prompt. For example, the style latent code encodes the stylistic attributes and aesthetic qualities specified by the style prompt.

In some examples, the content prompt is processed using pre-trained models or text encoders to extract meaningful features and convert them into a dense vector representation. For the style latent code, the system may use style encoders or pre-trained models that have learned to capture the distinctive characteristics of various artistic styles. In these examples, the style prompt is mapped to a style latent space, and each point represents a specific style or aesthetic.

At operation 715, the system combines the content latent code and the style latent code based on the visual intensity parameter to obtain a combined latent code. In some cases, the operations of this step refer to, or may be performed by, an image projector as described with reference to FIG. 5.

In some examples, at operation 715, the visual intensity parameter acts as a weighting factor that determines the relative influence of the content and style latent codes in the final image. For example, a higher visual intensity value gives more emphasis to the style latent code, producing a more stylized and aesthetically expressive image. For example, a lower visual intensity value prioritizes the content latent code, producing an image that is more faithful to the original content prompt.

At operation 720, the system generates, using an image generation model, a synthetic image based on the combined latent code, where the synthetic image includes the object from the content prompt, and where the synthetic image includes the style from the style prompt at a level based on the visual intensity parameter. In some cases, the operations of this step refer to, or may be performed by, an image generation model as described with reference to FIG. 5.

In some examples, the image generation model includes a latent diffusion model. In some examples, the image generation model includes a deep neural network trained to map latent codes to high-quality images. In some examples, the image generation model takes the combined latent code as input and progressively upsamples and refines the image through a set of convolutional and deconvolutional layers.

In some examples, during the image generation process, the image generation model learns to synthesize realistic textures, colors, and details while preserving the semantic content and applying the desired stylistic elements. The generated image includes the object specified in the content prompt, such as an astronaut or a cat, and incorporates the style from the style prompt, such as an oil painting or a cartoon effect. The level of the style's presence in the final image may be determined based on the visual intensity parameter, allowing for a range of visual expressions from subtle to highly stylized.

In some examples, the image generation model is trained on a large dataset of diverse images and their corresponding content and style labels. Through this training process, the image generation model learns to understand the relationship between the latent codes and the visual elements in the image.

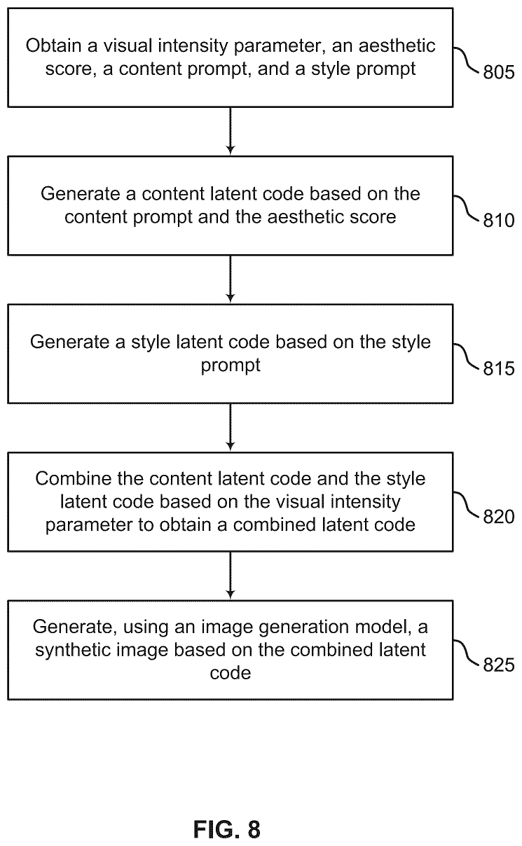

FIG. 8 shows an example of a method 800 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 805, the system obtains a visual intensity parameter, an aesthetic score, a content prompt, and a style prompt. In some cases, the operations of this step refer to, or may be performed by, a machine learning model as described with reference to FIG. 5.

In some examples, the visual intensity parameter is a user-specified value. The visual intensity parameter controls the balance between realism and stylization in the generated image. The aesthetic score represents the desired level of aesthetic appeal in the generated image. The content prompt describes the main subject or object to be depicted in the image. The style prompt specifies the artistic style or visual elements to be incorporated into the image.

At operation 810, the system generates a content latent code based on the content prompt and the aesthetic score. In some cases, the operations of this step refer to, or may be performed by, a text encoder as described with reference to FIG. 5.

In some examples, the content latent code is a compressed representation of the semantic information in the content prompt. The content latent code captures the essential features and characteristics of the main subject or object described in the content prompt. The aesthetic score influences the generation of the content latent code. The aesthetic score determines the level of aesthetic appeal to be incorporated into the content latent code.

At operation 815, the system generates a style latent code based on the style prompt. In some cases, the operations of this step refer to, or may be performed by, an image encoder as described with reference to FIG. 5.

In some examples, the system maps the style prompt to a style latent space. Each point in the style latent space represents a specific artistic style or aesthetic. The system generates the style latent code from the mapped style prompt in the style latent space. The image encoder performs the operations of this step.

In some examples, the style latent code encodes the stylistic attributes and visual qualities specified by the style prompt. The style latent code captures the distinctive characteristics of the desired artistic style. The pre-trained style encoders or models have learned to represent various artistic styles in the latent space.

At operation 820, the system combines the content latent code and the style latent code based on the visual intensity parameter to obtain a combined latent code. In some cases, the operations of this step refer to, or may be performed by, an image projector as described with reference to FIG. 5.

In some examples, the system determines the relative influence of the content latent code and the style latent code in the combined latent code based on the visual intensity parameter. The system employs techniques such as adaptive instance normalization or feature-wise linear modulation. The system blends the content latent code and the style latent code using the employed techniques. The system obtains the combined latent code from the blending of the content latent code and the style latent code. The image projector performs the operations of this step.

At operation 825, the system generates, using an image generation model, a synthetic image based on the combined latent code. In some cases, the operations of this step refer to, or may be performed by, an image generation model as described with reference to FIG. 5.

In some examples, operation 825 involves using an image generation model that is trained to map latent codes to high-quality images. The system provides the combined latent code as input to the image generation model. The image generation model progressively upsamples and refines the input to generate the synthetic image. The image generation model performs the operations of this step.

In some examples, prior to operation 825, the image generation model is trained to synthesize realistic textures, colors, and details during its training process. The image generation model has learned to preserve the semantic content and apply the desired stylistic elements during its training process. The generated synthetic image includes the object specified in the content prompt. The generated synthetic image incorporates the styles from the style prompt. The level of the styles' presence in the synthetic image is determined by the visual intensity parameter.

FIG. 9 shows an example of a computing device 900 according to aspects of the present disclosure. The computing device 900 is an example of, or includes aspects of, the corresponding element described with reference to FIGS. 1-6. The computing device 900 includes processor(s) 905, memory subsystem 910, communication interface 915, I/O interface 920, user interface component(s) 925, and channel 930.

In some embodiments, computing device 900 is an example of, or includes aspects of, the image generation apparatus described with reference to FIGS. 1-6. In some embodiments, computing device 900 includes one or more processors 905 that can execute instructions stored in memory subsystem 910 to generate synthetic images comprising a first attribute and a second attribute by providing a first attribute token to a first set layers of the image generation model during a first set of time-steps and providing a second attribute token to a second set of layers of the image generation model during a second set of time-steps According to some aspects, computing device 900 includes one or more processors 905. Processor(s) 905 are an example of, or includes aspects of, the processor unit as described with reference to FIG. 5. In some cases, a processor is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof.

In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special-purpose components for modem processing, baseband processing, digital signal processing, or transmission processing.

According to some aspects, memory subsystem 910 includes one or more memory devices. Memory subsystem 910 is an example of, or includes aspects of, the memory unit as described with reference to FIG. 5. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 915 operates at a boundary between communicating entities (such as computing device 900, one or more user devices, a cloud, and one or more databases) and channel 930 and can record and process communications. In some cases, communication interface 915 is provided to enable a processing system coupled to a transceiver (e.g., a transmitter and/or a receiver). In some examples, the transceiver is configured to transmit (or send) and receive signals for a communications device via an antenna.

According to some aspects, I/O interface 920 is controlled by an I/O controller to manage input and output signals for computing device 900. In some cases, I/O interface 920 manages peripherals not integrated into computing device 900. In some cases, I/O interface 920 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 920 or via hardware components controlled by the I/O controller.

According to some aspects, user interface component 925 enables a user to interact with computing device 900. In some cases, user interface component 925 includes an audio device, such as an external speaker system, an external display device such as a display screen, an input device (e.g., a remote-control device interfaced with a user interface directly or through the I/O controller), or a combination thereof. In some cases, user interface component 925 includes a GUI.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a content prompt, a style prompt, and a visual intensity parameter, wherein the content prompt indicates an object, the style prompt indicates a style, and the visual intensity parameter indicates a level of the style;
generating a content latent code and a style latent code based on the content prompt and the style prompt, respectively;
combining the content latent code and the style latent code based on the visual intensity parameter to obtain a combined latent code; and
generating, using an image generation model, a synthetic image based on the combined latent code, wherein the synthetic image includes the object from the content prompt and the style from the style prompt at the level indicated by the visual intensity parameter.

2. The method of claim 1, wherein obtaining the visual intensity parameter comprises:
receiving a user input via a visual intensity user interface element.

3. The method of claim 1, wherein obtaining the content prompt and the style prompt comprises:
obtaining a text prompt, wherein the content prompt and the style prompt are based on the text prompt.

4. The method of claim 3, wherein generating the style latent code comprises:
encoding the style prompt to obtain a text embedding; and
projecting the text embedding to obtain an image embedding, wherein the style latent code is based on the image embedding.

5. The method of claim 1, further comprising:
determining an aesthetic score based on the visual intensity parameter, wherein the content latent code is based on the aesthetic score.

6. The method of claim 1, wherein generating the content latent code and the style latent code comprises:
encoding the content prompt to obtain a text embedding;
encoding the style prompt to obtain an image embedding;
applying a text attention layer to the text embedding to obtain the content latent code; and
applying an image attention layer to the image embedding to obtain the style latent code.

7. The method of claim 1, wherein generating the content latent code and the style latent code comprises:
obtaining a noisy latent code, wherein the content latent code and the style latent code are generated based on the noisy latent code.

8. The method of claim 7, wherein generating the synthetic image comprises:
denoising the noisy latent code based on the combined latent code.

9. The method of claim 1, wherein generating the synthetic image comprises:
providing the combined latent code to each of a plurality of layers of the image generation model.

10. A method comprising:
obtaining an aesthetic score, a content prompt, and a style prompt;
generating a content latent code based on the content prompt and the aesthetic score;
generating a style latent code based on the style prompt;
combining the content latent code and the style latent code to obtain a combined latent code; and
generating, using an image generation model, a synthetic image based on the combined latent code.

11. The method of claim 10, wherein:
the aesthetic score is based on a visual intensity parameter.

12. The method of claim 10, wherein generating the content latent code and the style latent code comprises:
encoding the content prompt to obtain a text embedding;
encoding the style prompt to obtain an image embedding;
applying a text attention layer to the text embedding to obtain the content latent code; and
applying an image attention layer to the image embedding to obtain the style latent code.

13. An apparatus comprising:
at least one processor;
at least one memory storing instruction executable by the at least one processor; and
an image generation model comprising parameters stored in the at least one memory and trained to generate a content latent code and a style latent code based on a content prompt and a style prompt, respectively, combine the content latent code and the style latent code based on a visual intensity parameter to obtain a combined latent code, and generate a synthetic image based on the combined latent code.

14. The apparatus of claim 13, wherein:
the image generation model comprises a text attention layer configured to generate the content latent code and an image attention layer configured to generate the style latent code.

15. The apparatus of claim 13, wherein:
the image generation model comprises a text encoder configured to generate a text embedding based on the content prompt.

16. The apparatus of claim 13, wherein:
the image generation model comprises an image encoder configured to generate an image embedding based on the style prompt.

17. The apparatus of claim 13, wherein:
the image generation model comprises an image projector configured to convert a text embedding into an image embedding.

18. The apparatus of claim 13, wherein:
the image generation model comprises a latent diffusion model.

19. The apparatus of claim 13, further comprising:
a user interface configured to obtain the visual intensity parameter, the content prompt, and the style prompt.

20. The apparatus of claim 19, further comprising:
a visual intensity user interface element configured to obtain the visual intensity parameter.
